(19) United States
(12) Patent Application Publication
(10) Pub. No.: US 2019/0146620 A1
(43) Pub. Date: May 16, 2019

(54) DISPLAY DEVICE

(71) Applicant: Sharp Kabushiki Kaisha, Sakai City (JP)

(72) Inventors: Tatsuhiko SUYAMA, Sakai City (JP); Noriyuki TANAKA, Sakai City (JP); Daiji KITAGAWA, Sakai City (JP); Masaaki NISHIO, Sakai City (JP); Hongbing WENG, Sakai City (JP)

(21) Appl. No.: 16/183,775

(22) Filed: Nov. 8, 2018

(30) Foreign Application Priority Data
Nov. 14, 2017 (JP) 2017-219378

(51) Int. Cl. G06F 3/041; G06F 3/044; G09G 3/36

(52) U.S. Cl. CPC G06F 3/0412; G06F 3/044; G06F 3/0416; G09G 3/3677; G09G 3/3688; G09G 2310/0286; G09G 2320/10; G09G 2310/0202; G09G 2310/08

(57) ABSTRACT

Provided is a technique of making it possible to draw an image according to a locus of a finger or the like, irrespective of a frame rate.

A display device intermittently performs image display and touch position detection, and controls a frame frequency so that the frame frequency is variable. The display device includes: a display panel that includes a plurality of gate lines, and a touch detection element for the touch position detection; a gate line driving unit for scanning the gate lines; a touch detection driving unit that detects a touch position on the display panel; and a control unit that controls a scanning frequency for the gate lines. The touch detection driving unit performs the touch position detection at a constant frequency. The control unit adjusts the scanning frequency for the gate lines in one vertical scanning period, based on the frame frequency and the frequency for the touch position detection. The gate line driving unit scans the gate lines in accordance with the scanning frequency.

### TECHNICAL FIELD

The present invention relates to a display device.

### BACKGROUND ART

For example, Patent Document 1 indicated below discloses a display device that has a function of detecting touch position according to changes in electrostatic capacitances. This display device uses the counter electrodes provided on the counter substrate side of the display panel as electrodes for touch detection, and therefore, performs an operation of display on the liquid crystal display panel, and an operation of touch position detection, in a completely time-divided manner. More specifically, this display device executes the touch position detection, during one horizontal scanning period, at timings other than the timings when a gate line scanning voltage varies from a low level to a high level, and from the high level to the low level. Further, in a case where this display device performs the touch position detection a plurality of times over a plurality of horizontal scanning periods, the touch position detection is performed at a timing that is a predetermined time behind a timing when the horizontal synchronization signal rises to the high level, in every horizontal scanning period.

### PRIOR ART DOCUMENT

### Patent Document

Patent Document 1: JP-A-2013-231932

### SUMMARY OF THE INVENTION

### Problem to be Solved by the Invention

Incidentally, in a display device in which the operation of display and the operation of touch position detection are performed intermittently, the frequency detection of the touch position detection is determined according to the frequency of display in some cases. In such a case, the frequency of display is changed according to the frame rate, and the frequency detection of the touch position per unit time varies. As the frame rate is smaller, the number of the operations of touch position detection per unit time decreases. In a case where a curve line is drawn on the screen with a finger or the like, therefore, the locus of the finger or the like cannot be appropriately detected, and a smooth curve line cannot be drawn.

The following invention draws an image according to a locus of a finger or the like, irrespective of a frame rate.

### Means to Solve the Problem

A display device in one embodiment of the present invention intermittently performs image display and touch position detection, and controls a frame frequency so that the frame frequency is variable. The display device includes: a display panel that includes a plurality of gate lines, and a touch detection element for the touch position detection; a gate line driving circuitry for scanning the gate lines; a touch detection driving circuitry that controls the touch detection element, and detects a touch position on the display panel at a constant frequency; and a control circuitry that controls a scanning frequency for the gate lines in one vertical scanning period according to the frame frequency, wherein the gate line driving circuitry scans the gate lines in accordance with the scanning frequency.

### Effect of the Invention

With the present invention, it is possible to draw an image according to a locus of a finger or the like, irrespective of a frame rate.

### BRIEF DESCRIPTION OF DRAWINGS

FIG. 1 is a schematic cross-sectional view illustrating a display device in Embodiment 1.

FIG. 2A is a plan view illustrating a schematic configuration of the active matrix substrate illustrated in FIG. 1.

FIG. 2B is an equivalent circuit diagram of one pixel.

FIG. 3 is a plan view illustrating an exemplary arrangement of counter electrodes formed on the active matrix substrate illustrated in FIG. 2A.

FIG. 4 illustrates the voltage of the counter electrode in image display periods TD and touch position detection periods TP during one vertical scanning period.

FIG. 5A schematically illustrates, regarding each of frame rates that are different from each other, the image display periods and the touch position detection periods in one vertical scanning period in a conventional configuration.

FIG. 5B schematically illustrates, regarding each of frame rates that are different from each other, the image display periods and the touch position detection periods in one vertical scanning period in Embodiment 1.

FIG. 6 is a timing chart illustrating timings of touch position detection in Embodiment 1.

FIG. 7 illustrates image display periods and touch position detection periods during two vertical scanning periods in which vertical fly-back periods are different in Embodiment 2.

### MODE FOR CARRYING OUT THE INVENTION

A display device in one embodiment of the present invention intermittently performs image display and touch position detection, and controls a frame frequency so that the frame frequency is variable, and the display device includes: a display panel that includes a plurality of gate lines, and a touch detection element for the touch position detection; a gate line driving circuitry for scanning the gate lines; a touch detection driving circuitry that controls the touch detection element, and detects a touch position on the display panel at a constant frequency; and a control circuitry that controls a scanning frequency for the gate lines in one vertical scanning period according to the frame frequency, wherein the gate line driving circuitry scans the gate lines in accordance with the scanning frequency (the first configuration).

According to the first configuration, the touch position detection performed at a constant frequency, and the gate lines are scanned at the scanning frequency for the gate lines in one vertical scanning period based on the frequency for the touch position detection and the frame frequency. Accordingly, even if the frame frequency is changed, the number of operations of touch position detection per unit time is kept constant, which makes it possible to draw a smooth curve line according to a locus of a finger or the like.

The first configuration may be further characterized in that the gate line driving circuitry applies a scanning voltage for switching each gate line between a selection state and a non-selection state, and when the touch position detection is started, in a case where any one of the gate lines is in the selected state, the touch detection driving circuitry starts the touch position detection after a scanning voltage for switching the gate line being in the selected state into the non-selection state is applied (the second configuration).

With the second configuration, insufficient charging of the gate line in the selected state can be avoided, and therefore the touch position detection can be performed without occurrence of display defects.

The first or second configuration may be further characterized in that, in the one vertical scanning period, the gate line driving circuitry stops scanning the gate lines during a predetermined period other than the touch position detection period, and the control circuitry controls the scanning frequency based on the frame frequency and duration of the predetermined period (the third configuration).

According to the third configuration, the scanning of the gate lines is stopped during a predetermined period in one frame. Accordingly, the scanning frequency for the gate lines in the frame varies, whereas the number of operations of touch position detection per unit time is kept constant.

The third configuration may be further characterized in that the predetermined period is a vertical fly-back period (the fourth configuration).

The following description describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of a part of constituent members is omitted. Further, the dimension ratios of the constituent members illustrated in the drawings do not necessarily indicate the real dimension ratios.

### Embodiment 1

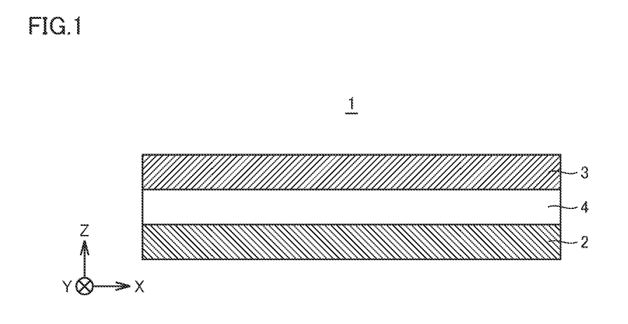

FIG. 1 is a schematic cross-sectional view of a display device in the present embodiment. The display device 1 in the present embodiment includes an active matrix substrate 2, a counter substrate 3, and a liquid crystal layer 4 interposed between the active matrix substrate 2 and the counter substrate 3. Each of the active matrix substrate 2 and the counter substrate 3 includes a glass substrate that is substantially transparent (having high translucency). Further, though the illustration is omitted, the display device 1 includes a backlight that is provided so as to extend in a surface direction of the active matrix substrate 2, on a side opposite to the liquid crystal layer 4 in FIG. 1, and a pair of polarizing plates between which the active matrix substrate 2 and the counter substrate 3 are interposed. Thought the illustration is omitted, the counter substrate 3 includes color filters of three colors of red (R), green (G), and blue (B).

The display device 1 has a function of displaying an image and a function of detecting a position at which a user has touched (a touch position) on the image displayed. This display device 1 is a so-called in-cell type touch panel display device wherein elements necessary for detecting a touch position are provided on the active matrix substrate 2.

Further, in the display device 1, the method for driving liquid crystal molecules contained in the liquid crystal layer 4 is the horizontal electric field driving method. To realize the horizontal electric field driving method, pixel electrodes and counter electrodes (common electrodes) for forming electric fields are formed on the active matrix substrate 2. The following description describes the configuration of the active matrix substrate 2 more specifically.

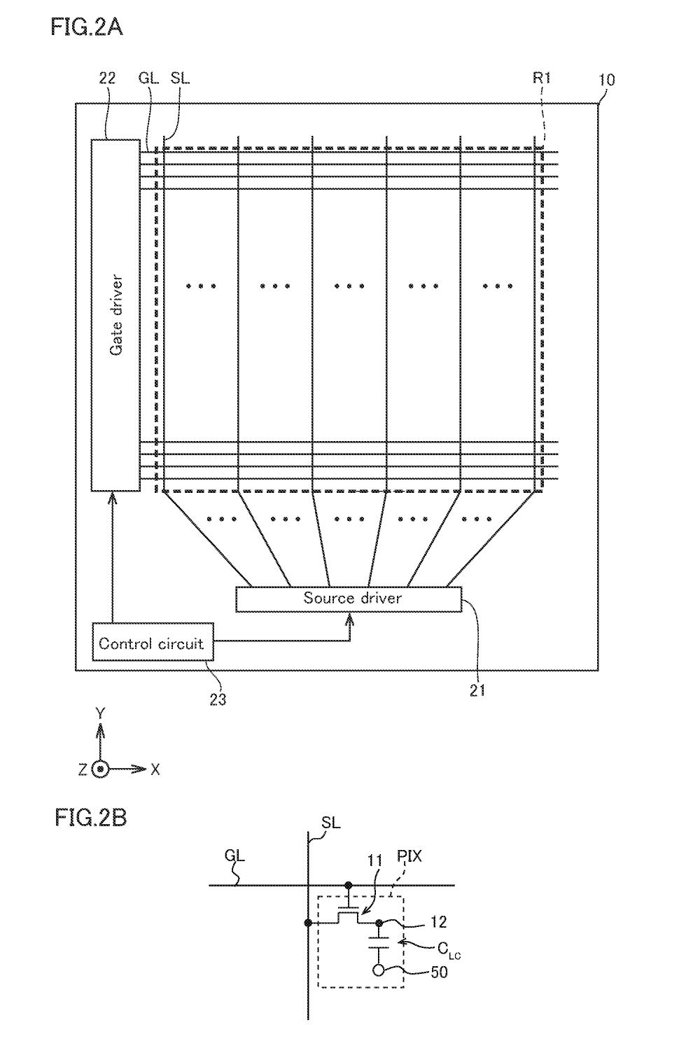

FIG. 2A is a plan view illustrating a schematic configuration of the active matrix substrate 2. As illustrated in FIG. 2A, the active matrix substrate 2 includes a plurality of gate lines GL, a plurality of source lines SL, a source driver 21, a gate driver 22, and a control circuit 23.

Though the illustration is omitted in this drawing, on the active matrix substrate 2, pixel electrodes are provided in areas defined by the gate lines GL and the source lines SL, respectively, and pixels are formed therein, respectively. The active matrix substrate 2 has a display area R1 composed of the pixels. Each pixel electrode corresponds to any one of the colors R, G, and B of the color filters (not shown) provided on the counter substrate 3.

FIG. 2B illustrates an equivalent circuit of one pixel. The pixel PIX includes a thin film transistor (TFT) 11, a pixel electrode 12, and a common electrode 50. The gate electrode of the TFT 11 is connected with the gate line GL, the source electrode thereof is connected with the source line SL, and the drain electrode thereof is connected with the pixel electrode 12. A liquid crystal capacitor C_{LC} is formed between the pixel electrode 12 and the counter electrode 50.

As illustrated in FIG. 2A, the source driver 21 and the gate driver 22 are provided in a frame region outside the display area R1. Further, as illustrated in FIG. 2A, the control circuit 23 is provided in a frame region and is connected with the source driver 21 and the gate driver 30.

The control circuit 23 supplies, to the gate driver 22, control signals such as synchronization signals (a vertical synchronization signal, a horizontal synchronization signal) indicating timings for writing images in the respective pixels, and clock signals for driving the source driver 21 and the gate driver 22, according to the frame rate. Further, the control circuit 23 controls the frame rate so that the frame rate can be varied at predetermined timings.

For example, in a case of displaying a still image, even if the frame rate is decreased, the electric power consumption can be reduced, while the image quality is maintained. In a case of displaying a moving image, more smooth motion display can be achieved by increasing the frame rate. The control circuit 23 may be configured so as to switch the frame rate according to the image to be displayed.

The gate driver 22 includes shift registers (not shown) that are provided in correspondence to the gate lines GL, respectively. The shift registers are connected with the gate lines corresponding thereto, respectively. The gate driver 22 applies, to each gate line GL, a scanning voltage that switches the gate line GL to a selected state or a non-selected state based on synchronization signals and control signals supplied from the control circuit 23. Hereinafter the state in which the gate line GL is selected is referred to as the scanning or the driving of the gate line GL in some cases.

The source driver 21 is connected with each source line SL. The source driver 21 supplies data signals for displaying images to the source lines SL based on the control signals supplied from the control circuit 23.

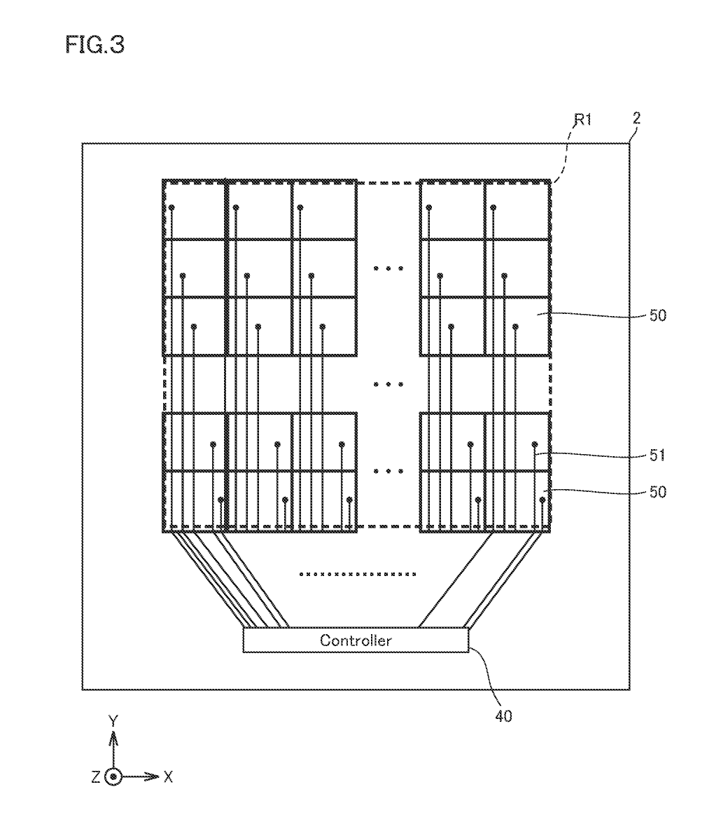

FIG. 3 schematically illustrates an exemplary arrangement of the counter electrodes 50 formed on the active matrix substrate 2. As illustrated in FIG. 3, each counter electrode 50 is in a rectangular shape, and a plurality of the same are arranged in matrix on the active matrix substrate 2. The counter electrodes 50 are provided in an upper layer with respect to the pixel electrodes 12, on a liquid crystal layer 4 side surface (see FIG. 1) of the active matrix substrate 2. Each of the counter electrodes 50 is, for example, approximately in a square shape whose side is several millimeters, and is larger than the pixel. Though the illustration is omitted in this drawing, in the counter electrodes 50, slits (having a width of, for example, several micrometers) are formed for causing horizontal electric fields to be generated between the same and the pixel electrodes 12.

The active matrix substrate 2 includes a controller 40 on a frame region side where the source driver 21 illustrated in FIG. 2 is provided. The controller 40 performs image display control for displaying images, and performs touch position detection control for detecting a touch position.

The controller 40 and each counter electrode 50 are connected with each other by a signal line 51 that extends in the Y axis direction. In other words, the signal lines 51, the number of which is the same as the number of the counter electrodes 50, are formed on the active matrix substrate 2. Further, the controller 40 is connected with the control circuit 23 (see FIG. 2A).

The counter electrodes 50 are used, in pair with the pixel electrodes 12 (see FIG. 2B), in the control of image display, as well as in the control of touch position detection.

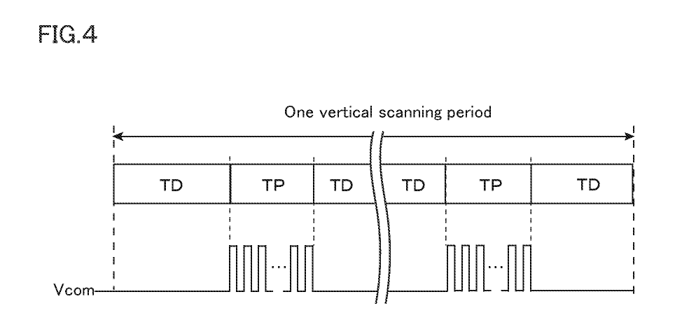

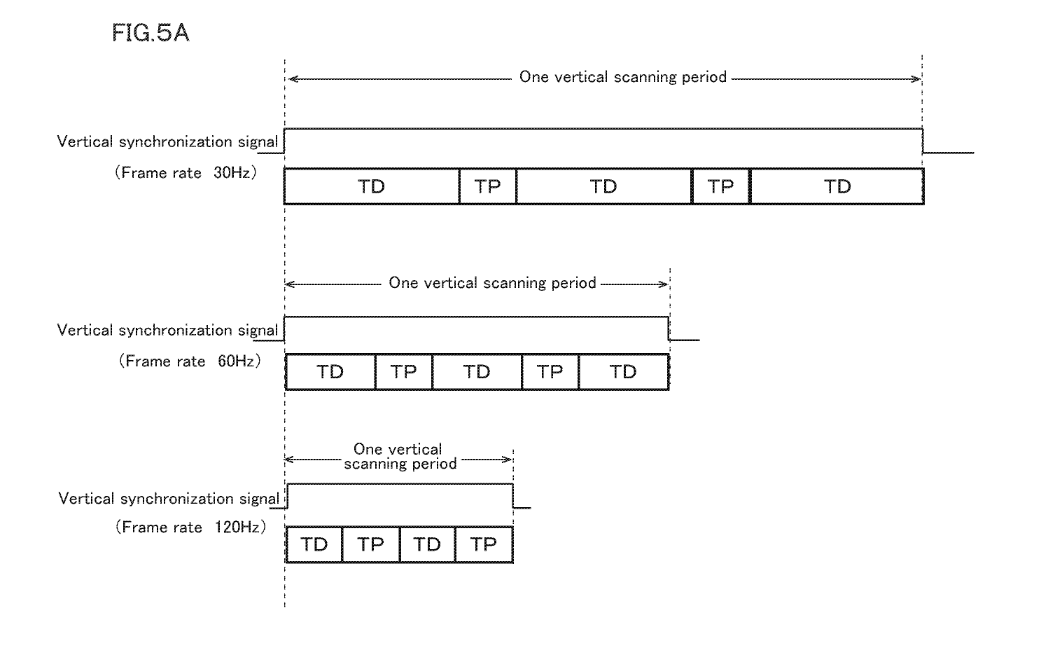

In the present embodiment, the frequency for the touch position detection (hereinafter referred to as touch detection frequency) is uniform, and as illustrated in FIG. 4, the touch position detection period TP and the image display period TD are provided alternately during one vertical scanning period. During the touch position detection period TP, the scanning of the gate lines GL is stopped.

The controller 40 supplies a constant direct current signal, as a signal Vcom for the counter electrodes 50, to the signal lines 51 (see FIG. 3) during the image display period TD, so as to cause the counter electrodes 50 to function as common electrodes. Further, during the touch position detection period TP, the controller 40 supplies an alternate current signal having a constant amplitude (hereinafter referred to as a touch driving signal) as a signal Vcom to the signal lines 51.

The operation of touch position detection is performed in the following manner. Parasitic capacitances are formed between adjacent ones of the counter electrodes 50 and the like. When a human finger or the like touches the display screen of the display device 1, a capacitor is formed between the counter electrodes 50 and the human finger or the like, whereby the electrostatic capacitance increases. In the operation of touch position detection, each counter electrode 50 receives the touch driving signal supplied via the corresponding one of the signal lines 51, and outputs changes in the electrostatic capacitance at the position of the counter electrode 50, via the signal line 51 to the controller 40. In other words, an operation that includes the supply of the touch driving signal to every counter electrode 50 and the reception by the controller 40 of changes in the electrostatic capacitance at the position of every counter electrode 50 is one operation of touch position detection.

As described above, since the touch detection frequency is constant, the control circuit 23 adjusts the scanning frequency for the gate lines GL in one vertical scanning period according to the touch detection frequency and the frame rate. The control circuit 23 supplies the horizontal synchronization signal according to the scanning frequency, to the gate driver 22. The gate driver 22 scans the gate lines GL based on the horizontal synchronization signal supplied from the control circuit 23.

In a case where the touch detection frequency is fp (Hz) (fp<fr) with respect to the frame rate fr (Hz), the scanning time T while M gate lines GL (M: a natural number equal to or greater than 1) are scanned during one vertical scanning period is about (1/fr−fpΔt/fr) seconds (Δt: time for one operation of touch position detection). The control circuit 23 adjusts the scanning frequency for scanning the gate lines GL to M×T (Hz), and causes the gate lines GL to be scanned at this scanning frequency.

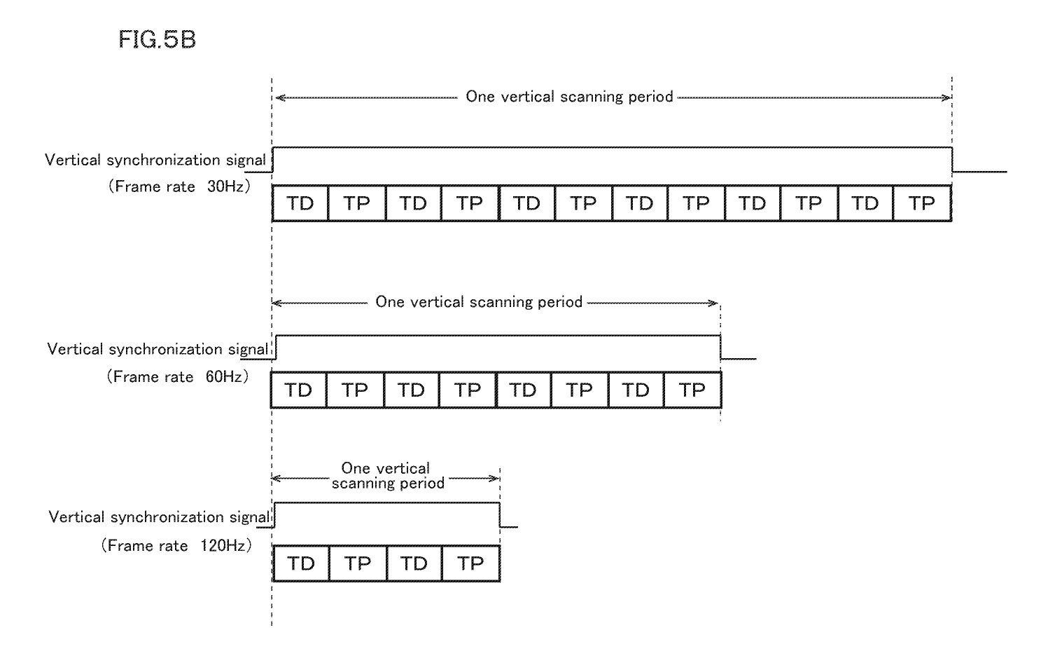

In the conventional case, as illustrated in FIG. 5A, the number of operations of the touch position detection per unit time varies as the frame rate is changed to 30 Hz, 60 Hz, 120 Hz. On the other hand, in the present embodiment, as illustrated in FIG. 5B, even if the frame rate is changed to any of 30 Hz, 60 Hz, 120 Hz, the number of operations of the touch position detection operations per unit time is constant, and the scanning frequency is adjusted for every frame rate, according to the touch detection frequency and the frame rate. As a result, regarding the number of the gate lines GL scanned during one image display period TD when the frame rate is 30 Hz, that when the frame rate is 60 Hz, and that when the frame rate is 120 Hz, the ratio of these numbers is approximately 1:2:4.

The foregoing description describes an example in which the scanning frequency determined by computation based on the frame rate and the touch detection frequency; in a case where the frame rate is preliminarily determined, however, scanning frequencies preliminarily determined by computation for each frame rate may be stored in a memory or the like. In this case, whenever frame rate is changed, the control circuit 23 reads out a scanning frequency corresponding to the frame rate, and based on the scanning frequency thus read out, supplies a horizontal synchronization signal to the gate driver 22.

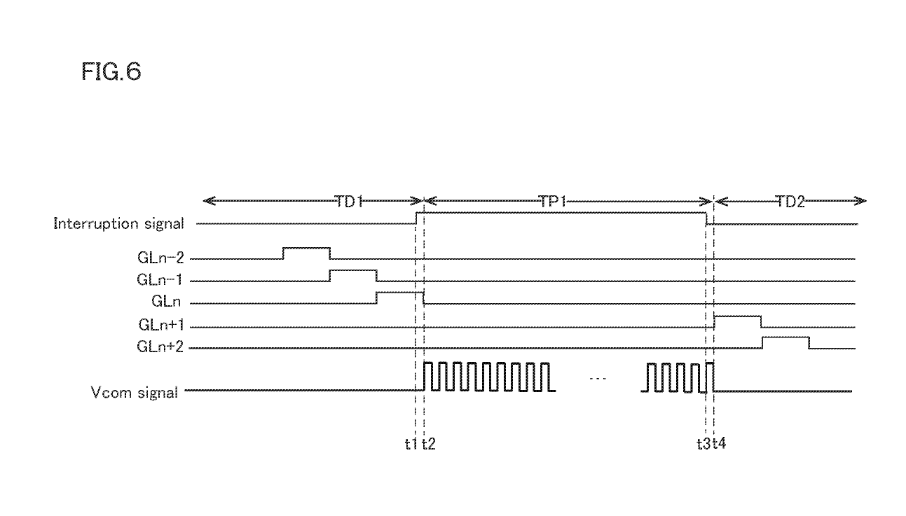

Here, the following description describes operations of the display device 1 during the image display period TD and the touch position detection period TP. FIG. 6 illustrates a timing chart that illustrates timings of the touch position detection.

First, during the image display period TD1, the control circuit 23 supplies synchronization signals and control signals according to the frame rate and the touch detection frequency to the gate driver 22 and the source driver 21. In the image display period TD1, the controller 40 supplies a constant direct current signal as the signal Vcom to the counter electrodes 50. With this, the gate lines GL are sequentially scanned by the gate driver 22, data signals are supplied from the source driver 21 to the source lines SL, and images are written in the pixels corresponding to the scanned gate lines GL.

The controller 40 outputs an interruption signal having a potential at a high (H) level that indicates the start of the touch position detection, to the control circuit 23, according to the touch detection frequency.

At a timing (t1) when the interruption signal at the H level is output, the gate line GLn is in a selected state. The control circuit 23 keeps supplying the control signals to the gate driver 22 and the source driver 21, until the gate line GLn is switched to a non-selection state. After a scanning voltage for the non-selection is applied to the gate line GLn, the control circuit 23 stops supplying the control signals to the gate driver 22 and the source driver 21. This causes images to be written up to the pixels to which the gate line GLn is connected, and the scanning of the gate lines GL subsequent thereto is stopped.

In this way, in a case where there is a gate line GLn in a selected state when the touch position detection is to be started, the gate line GLn is switched to a non-selected state, and thereafter, the touch position detection is started. This makes it possible to surely perform the writing of data to the pixels while avoiding insufficient charging of the gate line GLn, thereby causing display defects to hardly occur.

The controller 40 supplies a touch driving signal as a signal Vcom to the counter electrodes 50 at a timing (t2) when the gate line GLn is switched to a non-selected state, so as to perform the touch position detection. This causes the touch position detection period TP to be started.

When the touch position detection period TP ends, the controller 40 outputs an interruption signal at a level Low (L), and supplies a constant DC electric current as a signal Vcom to the counter electrodes 50. Here, the control circuit 23 resumes the supply of the control signals to the gate driver 22 and the source driver 21. With this, the gate line GLn+1 and the subsequent gate lines are sequentially scanned by the gate driver 22, data signals are supplied to the source lines SL by the source driver 21, and the image display period TD2 is started.

In the above-described embodiment, the touch position detection is performed with use of a constant frequency, and the scanning frequency for scanning the gate lines GL is adjusted based on the frame rate and the touch detection frequency. In other words, the number of operations of the touch position detection, that is, the touch position detection time, per unit time during one vertical scanning period is constant, and the scanning frequency may be determined in such a manner that all of the gate lines GL are scanned in the time other than the touch position detection time. Conventionally, in a case where the touch detection frequency is varied according to the frame rate, the number of operations of the touch position detection per unit time decreases as the frame rate decreases. As a result, in a case where, for example, a curve line is drawn with a finger or the like sliding on the screen, smoothness is lost, and there arises a problem that smooth curve lines according to the locus of the finger cannot be drawn. In the above-described embodiment, the number of operations of the touch position detection per unit time is kept constant even if the frame rate is changed, the smoothness of curve lines is not lost, and smooth curve lines can be drawn.

### Embodiment 2

In Embodiment 1 described above, for example, a pausing period while the gate lines GL are not driven may be provided during one vertical scanning period, in addition to the touch position detection period. In this case, during the pausing period, the scanning of the gate lines GL is stopped, but the touch position detection is performed even during the pausing period as well.

The pausing period may be, for example, a vertical fly-back period. The configuration may be such that the frequency of image display in one vertical scanning period (one frame) may be varied by varying the duration of the vertical fly-back period.

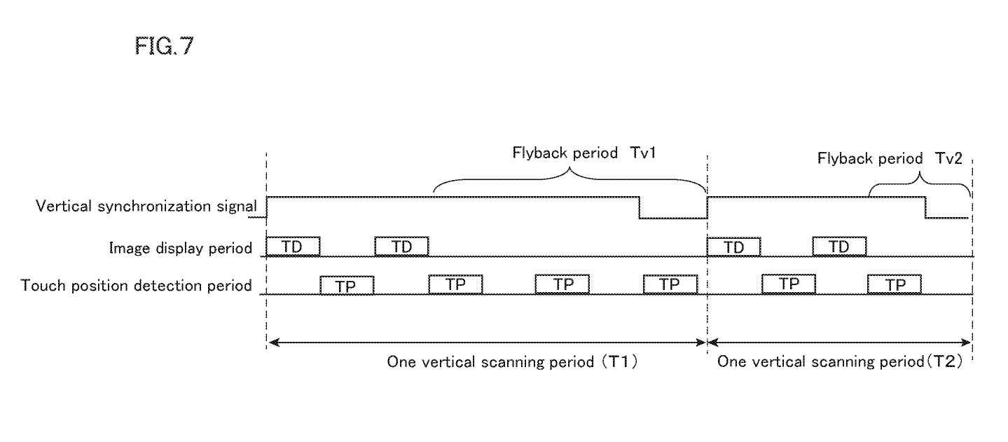

FIG. 7 illustrates timings of image display and touch position detection during two vertical scanning periods in which vertical fly-back periods are different. In FIG. 7, a fly-back period Tv1 is longer than a fly-back period Tv2.

The controller 40 performs the touch position detection at a constant frequency during the fly-back periods Tv1, Tv2 as well. In each frame of the vertical scanning periods T1 and the vertical scanning period T2, the control unit 23 adjusts the scanning frequency according to the image display frequency and the touch detection frequency of the frame. In other words, the number of operations of the touch position detection, that is, the touch position detection time, per unit time during one vertical scanning period is constant, and the scanning frequency may be determined in such a manner that all of the gate lines GL are scanned in the time other than the touch position detection time and the fly-back period.

With the above-described configuration, the number of operations of the touch position detection per unit time is kept constant even if the image display frequency per frame is varied, whereby smooth curve lines and the like according to the locus of the finger on the screen can be drawn.

Embodiment 2 described above is described with reference to an example in which the pausing period is the vertical fly-back period, but a pausing period while the scanning of the gate lines GL is stopped in one vertical scanning period may be provided in a period other than the vertical fly-back period. More specifically, for example, the configuration may be as follows: in a display device, two divided areas of the display area, divided along a line parallel with the gate lines, are provided with backlights, respectively, and only one of the backlights is turn on so that image display is performed, while the image display is stopped in the other divided area. Here, the gate lines GL in one of the divided areas are scanned, and the scanning of the gate lines GL in the other divided area is stopped. In this case, the period while the scanning of the gate lines GL in the other divided area is stopped is the pausing period.

Exemplary display devices according to the present invention are described above, but the configuration of the display device according to the present invention is not limited to the configuration of Embodiments described above; it may be varied in many ways. The following description describes a modification example of the same.

(1) The above-described embodiments are described with reference to, as an example, a display device in which liquid crystal is used, but any of the configurations of the above-described embodiments may be applied to a display in which organic electroluminescence (EL) is used.

### DESCRIPTION OF REFERENCE NUMERALS

1: display device
2: active matrix substrate
3: counter substrate
4: liquid crystal layer
21: source driver
22: gate driver:
23: control circuit
40: controller
50: counter electrode (common electrode)
51: signal line

1. A display device that intermittently performs image display and touch position detection, and controls a frame frequency so that the frame frequency is variable, the display device comprising:
a display panel that includes a plurality of gate lines, and a touch detection element for the touch position detection;
a gate line driving circuitry for scanning the gate lines;
a touch detection driving circuitry that controls the touch detection element, and detects a touch position on the display panel at a constant frequency; and
a control circuitry that controls a scanning frequency for the gate lines in one vertical scanning period according to the frame frequency,
wherein the gate line driving circuitry scans the gate lines in accordance with the scanning frequency.

2. The display device according to claim 1,
wherein the gate line driving circuitry applies a scanning voltage for switching each gate line between a selection state and a non-selection state, and
when the touch position detection is started, in a case where any one of the gate lines is in the selected state, the touch detection driving circuitry starts the touch position detection after a scanning voltage for switching the gate line being in the selected state into the non-selection state is applied.

3. The display device according to claim 1,
wherein, in the one vertical scanning period, the gate line driving circuitry stops scanning the gate lines during a predetermined period other than the touch position detection period, and
the control circuitry controls the scanning frequency based on the frame frequency and duration of the predetermined period.

4. The display device according to claim 3,
wherein the predetermined period is a vertical fly-back period.
